(19) United States
(12) Patent Application Publication
(10) Pub. No.: US 2009/0292626 A1
(43) Pub. Date: Nov. 26, 2009

(54) SYSTEM AND METHOD FOR INTERACTIVE MAP, DATABASE, AND SOCIAL NETWORKING ENGINE

(76) Inventor: J. Craig Oxford, Nashville, TN (US)

Correspondence Address: W. EDWARD RAMAGE, COMMERCE CENTER SUITE 1000, 211 COMMERCE ST, NASHVILLE, TN, 37201, US

(21) Appl. No.: 12/428,194

(22) Filed: Apr. 22, 2009

Related U.S. Application Data
(60) Provisional application No. 61/047,095, filed on Apr. 22, 2008.

(51) Int. Cl. G06Q 30/00; G06F 17/30

(52) U.S. Cl. 705/27; 707/3; 707/E17.014; 707/E17.044

(57) ABSTRACT

A system and method for selling or assigning locations to a purchaser. The location can be identified or delineated in several ways. Location identifiers may be used separately or in conjunction with each other. Sale of a particular location may be exclusive, partially-exclusive, or non-exclusive, depending on the particular embodiment of the system. A purchaser or potential purchaser may use digital, zoomable maps to identify locations of interest and possible purchase. The maps may be marked with locations already purchased, and this marking may be turned on and off by the purchaser when viewing the maps. In another embodiment, purchasers also have the option of expanding their participation to other linked aspects of the present invention, including but not limited to Web-based or other electronic access to interactive interfaces and/or social networking engines. Thus, for example, each assigned or purchased location, delineated by latitude and longitude, altitude, depth, and/or geographic or common name, may be identified on digital, zoomable Earth maps so that a user may view data input by other users regarding a particular location. Users also may register or subscribe to input data of their own regarding the location, and communicate electronically with other users of the invention.

This application claims benefit of and priority to U.S. Provisional Application No. 61/047,095, entitled “SYSTEM AND METHOD FOR INTERACTIVE MAP, DATABASE, AND SOCIAL NETWORKING ENGINE,” filed Apr. 22, 2008, and is entitled to that filing date for priority. The specification, drawings, attachments, and complete disclosure of U.S. Provisional Application No. 61/047,095 are incorporated herein by specific reference for all purposes.

### FIELD OF INVENTION

This invention relates to a method and process of assigning and selling certain associative rights to specific locations, and building a social network based upon shared locations. More specifically, this invention relates to a method of process of assigning and selling rights to specific locations in conjunction with digital, zoomable maps, and linking the locations to an interactive, extensible, Web-accessible database and social networking engine.

### BACKGROUND

A social network is a set of entities that interact in a variety of ways in social relationships. Entities that engage in social relationships may include individuals, families, groups, teams, and other organizations. The interaction between the network members, which often involves the exchange of information, promises, commitments, and the like, forms the social relationships between the entities in the social network.

People often develop attachments or connections with specific locations, such as the place where a couple first became engaged, or a location where a young athlete hit his or her first home run. Over time, certain locations may possess many such connections with a plurality of individuals or entities. What is needed is a system for allowing people to formalize their connection with a specific location, and to form a social network based on these connections and locations.

### SUMMARY OF THE INVENTION

In one exemplary embodiment, the system and method of the present invention assigns locations to a purchaser. The location can be identified or delineated in several ways: latitude and longitude, altitude and depth, name, seat number, or other ways of distinguishing or identifying a place or locations. The precision of the location delineation also may vary. In one embodiment, the identification of latitude and longitude may use arc seconds and fractions of arc seconds, while altitude and depth may be measured in feet and inches (or the metric equivalent).

The above location identifiers may be used separately or in conjunction with each other. For example, a particular table at a restaurant, a campsite, a reef, or a mountain summit may be identified by latitude, longitude, and height above (or below) sea level.

Sale of a particular location may be exclusive, partially-exclusive, or non-exclusive, depending on the particular embodiment of the system. In one exemplary embodiment, a particular location may be sold to numerous purchasers. In another embodiment, a purchaser may have exclusive rights to a particular height or depth at a particular latitude and longitude, but others can purchase other heights or depths at that same latitude and longitude. In yet another embodiment, a purchaser may be able to purchase all heights or depths at a particular latitude and longitude. A purchaser or potential purchaser may use digital, zoomable maps to identify locations of interest and possible purchase. The maps may be marked with locations already purchased, and this marking may be turned on and off by the purchaser when viewing the maps.

In another embodiment, purchasers also have the option of expanding their participation to other linked aspects of the present invention, including but not limited to Web-based or other electronic access to interactive interfaces and/or social networking engines. Thus, for example, each assigned or purchased location, delineated by latitude and longitude, altitude, depth, and/or geographic or common name, may be identified on digital, zoomable Earth maps so that a user may view data input by other users regarding a particular location. Users also may register or subscribe to input data of their own regarding the location, communicate electronically with other users of the invention, and purchase content such as photographs, satellite photos with different resolutions or from different altitudes, video, narrative, maps, commemorative gifts, and music offered for sale by the operator of the invention or others. The data input may include, but is not limited to, personal information about the user, hobbies, music preferences, travel destinations, reasons why the users go to those locations or destinations, and the like. The information may be stored in one or more databases connected to a computer or computer network.

### BRIEF DESCRIPTION OF THE DRAWINGS

FIG. 1 is a diagram of steps in accordance with an exemplary embodiment of the present invention.

FIG. 2 shows an exemplary computing environment in which embodiments of the present invention may be implemented.

### DETAILED DESCRIPTION OF EXEMPLARY EMBODIMENTS

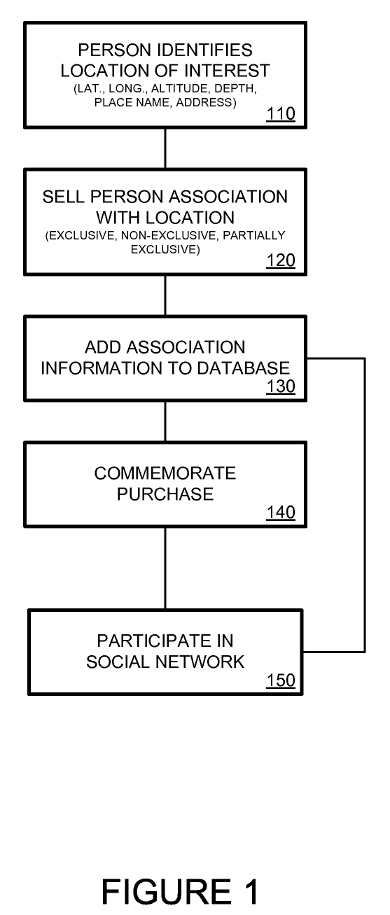

In various embodiments, the present invention comprises a method and process for linking specific locations on digital, zoomable maps of the Earth to an interactive, extensible, Web-accessible database and social networking engine, and assigning and selling rights to those locations to purchasers, as shown in FIG. 1.

In one embodiment, the system and method of the present invention assigns locations to a purchaser. The location can be identified or delineated in several ways 110. In one embodiment, the location is delineated by latitude and longitude. In another embodiment, the location may be further identified by altitude and/or depth in addition to latitude and longitude. The precision of the location delineation also may vary. In one variation, the identification of latitude and longitude may use arc seconds and fractions of arc seconds, while altitude and depth may be measured in feet and inches (or the metric equivalent).

In yet another embodiment, locations may be identified by a name (such as, but not limited to, a geographic or common name) or structure (such as, but not limited to, a particular restaurant, hotel, stadium, arena, etc.). The location may be further specified, such as a specific seat (or seats) in a stadium, a specific room in a hotel, or a specific table at a restaurant.

The above location identifiers may be used separately or in conjunction with each other. For example, a particular table at a restaurant may also be identified by latitude, longitude, and height above sea level.

Sale of a particular location 120 may be exclusive, partially-exclusive, or non-exclusive, depending on the particular embodiment of the system. In one exemplary embodiment, a particular location may be sold to numerous purchasers. In another embodiment, a purchaser may have exclusive rights to a particular height or depth at a particular latitude and longitude, but others can purchase other heights or depths at that same latitude and longitude. In yet another embodiment, a purchaser may be able to purchase all heights or depths at a particular latitude and longitude.

A purchaser or potential purchaser may use digital, zoomable maps to identify locations of interest 110 and possible purchase 120. The maps may be marked with locations already purchased, and this marking may be turned on and off by the purchaser when viewing the maps.

A purchaser of a location may be offered various ways to commemorate 140 the purchase, including but not limited to plaques, maps, placemats, hat, shirt, bracelet, certificate, cup, glass, or similar items. Thus, for example, a purchaser could obtain rights to an assigned location on a map representing a place of personal significance, such as a favored mooring spot for a boat, the location of a burial at sea, a mountain peak climbed, the location and altitude of a private aviation accomplishment, or a current or former residence, and receives a commemorative item or gift, such as a high-quality plaque or map, recognizing the purchase and commemorating the significance to them of the location purchased.

In one embodiment, users purchase the location using a kiosk or computer in a shop or store. The database storing the location data, including locations that have been purchased, may be local and limited to that particular kiosk or computer. In another embodiment, a database of wider scope may be used to store the location data and be accessible through the Internet or a website.

In one embodiment, purchasers also have the option of expanding their participation to other linked aspects of the present invention, including but not limited to Web-based or other electronic access to interactive interfaces and/or social networking engines 150. Thus, for example, each assigned or purchased location, delineated by latitude and longitude, altitude, depth, and/or geographic or common name, may be identified on digital, zoomable Earth maps so that a user may view data input by other users regarding a particular location. Users also may register or subscribe to input data of their own regarding the location, communicate electronically with other users of the invention, and purchase content such as photographs, satellite photos with different resolutions or from different altitudes, video, narrative, maps, commemorative gifts, and music offered for sale by the operator of the invention or others. The data input may include, but is not limited to, personal information about the user, hobbies, music preferences, travel destinations, reasons why the users go to those locations or destinations, etc. The information may be stored in one or more databases.

Accordingly, a purchaser could use this embodiment of the invention to purchase or otherwise obtain limited rights to an assigned location on a map representing a place of personal significance to them, such as the place where they were born, a favorite restaurant, or a honeymoon location, and permit purchasers to use the invention to input their own content regarding the location, view content input by others, communicate and interact with other users of the invention, and access content and advertising linked to and managed by the invention that is tailored to the location and the purchaser's interests.

In this embodiment, users who have similar interests regarding a particular place or location would be able to identify each other, and communicate or network with each other. For example, a couple who had a honeymoon at a villa at a particular island would be able to purchase the location of that villa, assign their name and date to that location, and receive a certificate, map or chart commemorating the purchase. The information would then be posted to a central database to which users could subscribe (subscriptions could be paid for with a single up-front payment, or for a periodic subscription fee, such as $10 per month or $100 per year). Subscribers could then share music, photos, or videos and communicate with others who have an interest in common with a particular location or place.

Another embodiment is a social networking site for travelers who have “gone somewhere.” Users can mark locations by date and time of visit.

Users may conduct searches on the database (or databases) to see what other users have interest in particular locations or topics. The database also may be searched by businesses and third parties, with a fee charged for the searches. The extensible database also may include metadata, which would permit database searches on the metadata.

In another embodiment, as users identify locations or topics of interest, they are provided the opportunity to conduct searches on those locations or topics. They may be directed to a separate search engine site, or a search engine can be licensed and provided through the website. A fee can be received from the search engine provided for each search directed from or through the website. A fee also may be received from particular websites that users are directed to.

The website also may include a variety of advertisements or banners related to the specific locations or topics the user is interested in or has searched. Fees can be charged for those advertisements and banners, and additional fees can be charged for click-throughs and/or purchases resulting from the click-throughs. Photos, music, and other items also may be sold at or through the website. Various embodiments of the present invention thus would generate large amounts of traffic on the website and on affiliated websites, and revenues generated from users and visitors, as well as by selling links and advertising on the website.

In yet another embodiment, a place of business can have a kiosk enabling people to join a community of people who have been to the location. With an initial payment, they get a certificate or map, and are invited to access a “You were here” club through the Internet to see who else has been there and communicate with them. The kiosk can be at a bar, a restaurant, or a stadium. Thus, for example, a football stadium may have multiple kiosks, and allow users to commemorate a particular game by latitude, longitude, and section and seat numbers.

In yet another embodiment, date and/or time identifiers can be combined with location identifiers (as discussed above). Users can purchase a particular date and/or time (or dates or times) of personal interest (such as a wedding day) associated with a particular location.

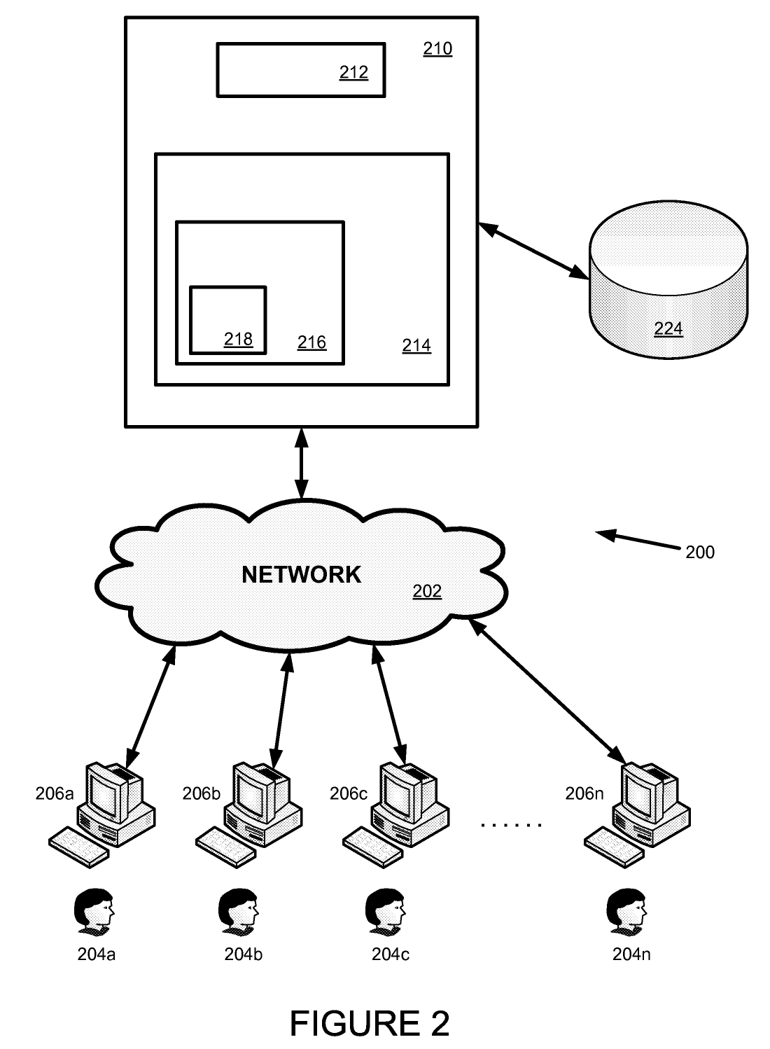

In order to provide a context for the various aspects of the invention, FIG. 2 and the following discussion provide a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components shown in FIG. 2, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objections, components, routines, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

FIG. 2 shows a computer system 200 comprising multiple client devices 206a,b,c-n in communication with at least one server device 210 through or over a network 202. In various embodiments, the network 202 may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices 204 also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices.

Users 204a,b,c-n may communicate with each other, and with other systems, networks, and devices, over the network through the respective client device. In the embodiment shown in FIG. 1, the network is also coupled to a server device 210. Server device 210 comprises a server executing a social network engine application or program 216. The social network engine 216 allows users to participate in a social network. A social network can refer to a computer network connecting entities, such as people or organizations, by a set of social relationships, such as friendship, co-working, or information exchange, and may also refer to the computer application or data itself.

In the exemplary embodiment show, server device 210 comprises a processor 212 coupled to a computer-readable memory 214. Server device 210 is in communication with at least one social network database 224. The server device, while shown as a single computer system, may be implemented as a network of computer processors. Examples of server devices include, but are not limited to, servers, mainframe computers, networked computers, a processor-based device, and similar types of systems and devices. Memory 214 contains a social network engine application or program 216. The social network engine application or program 216 facilitates members participating in a social network.

It should be understood that the embodiments and examples described herein have been chosen and described in order to best illustrate the principles, methods, and processes of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A computer implemented system for building a social network, comprising
a database for storing electronic information about a plurality of specific locations, said electronic information including identification information for one or more persons associated with each location;
a query engine responsive to a user request to query said database for identifying associations between persons and locations.

2. The system of claim 1, wherein the electronic information further includes secondary information relating to or describing the association between the one or more persons and a specific location.

3. The system of claim 1, wherein some or all of the specific locations are identified by latitude and longitude.

4. The system of claim 1, wherein some or all of the specific locations are identified by altitude or depth.

5. The system of claim 1, wherein some or all of the specific locations are identified by name or address.

6. The system of claim 1, wherein one or more persons purchase an association with the particular location to become associated with that location.

7. The system of claim 1, further comprising means for communication between said user and the one or more persons associated with a particular location.

8. The system of claim 1, wherein items or services, or both, may be offered for sale or trade in response to a query.

9. The system of claim 1, wherein the items or services offered are selected based upon the particular location.

10. A computer-readable storage medium on which is encoded program code, the program code comprising:
program code for providing an interface to a user, wherein the interface allows the user to request information about a particular location from a social network;
program code for receiving the information request from the user, wherein the information request comprises at least a location identifier; and
program code for providing information about the particular location in response to the information request.

11. The computer-readable storage medium of claim 10, wherein the information request comprises a request for identification of members in the social network associated with the particular location.

12. The computer-readable storage medium of claim 10, wherein the information request comprises a request for identification of members in the social network associated with any location within a selected distance from the particular location.

13. The computer-readable storage medium of claim 11, wherein members of the social network purchase an association with a particular location to become associated with that location.

14. The computer-readable storage medium of claim 13, wherein there are several levels of association.

15. The computer-readable storage medium of claim 10, further comprising program code for offering items or services for sale.

16. The computer-readable storage medium of claim 15, wherein the items or services offered are selected based upon the particular location.

17. The computer-readable storage medium of claim 10, further comprising program code for storing the requested information.

18. A computer-implemented method for providing associations with a location, comprising the following steps:
providing means to identify a particular location;
receiving a request to associate a particular location with one or more persons or entities; and
associating a particular location with one or more persons or entities in response to said request.

19. The method of claim 18, wherein information about the association between the particular location and one or more persons or entities is stored in a database in electronic communication with a computer.

20. The method of claim 19, further comprising providing access to a plurality of persons or entities to a network based upon a plurality of said associations.
